(19) United States
(12) Patent Application Publication
(10) Pub. No.: US 2025/0296233 A1
(43) Pub. Date: Sep. 25, 2025

(54) ROBOT, ROBOT CONTROL METHOD, AND COMPUTER PROGRAM

(71) Applicant: National University Corporation Tokai National Higher Education and Research System, Nagoya-shi, Aichi (JP)

(72) Inventors: Takuro YONEZAWA, Nagoya-shi, Aichi (JP); Nobuo KAWAGUCHI, Nagoya-shi, Aichi (JP); Kenta URANO, Nagoya-shi, Aichi (JP); Yutaro KYONO, Nagoya-shi, Aichi (JP)

(21) Appl. No.: 18/867,895

(22) PCT Filed: Oct. 7, 2022
(86) PCT No.: PCT/JP2022/037654

§ 371 Date: Nov. 21, 2024

(30) Foreign Application Priority Data
May 24, 2022 (JP) 2022-084216

(51) Int. Cl. B25J 9/16; B25J 19/04

(52) U.S. Cl. CPC B25J 9/1689; B25J 9/1602; B25J 9/162; B25J 19/04

(57) ABSTRACT

A robot includes a display, a camera, a communication interface, a moving mechanism, and a control unit. The control unit includes a movement control unit, a remote video image processing unit, and a local video image processing unit. The movement control unit controls the moving mechanism to move the robot. The remote video image processing unit acquires a remote video image including video images representing a plurality of remote users located at sites different from the current location of the robot from an external network via a communication interface, and displays the acquired remote video image on the display. The local video image processing unit transmits a local video image, which is a video image captured by the camera, to the external network via the communication interface to cause the plurality of remote users to view the local video image.

### TECHNICAL FIELD

The technology disclosed herein relates to a robot, a robot control method, and a computer program.

### BACKGROUND

There is known a technology called telexistence (tele-existence or tele-presence) which uses a robot as an alter ego of a human located at a site different from the robot. This technology allows a robot located at one site (local site) to be possessed (dominated) by a person at another site (remote site), thereby implementing real-time communication and/or interaction (hereinafter simply referred to as “communication”) between the person at the remote site and another person at the local site (see, e.g., JP2018-23464A).

### SUMMARY

### Technical Problem

Conventional telexistence technology tends to create a psychological gap in communication between a remote person and a local person, because only one person at a remote site possesses one robot at a local site. For example, a person located at the local site tends to think, “I have to keep talking with this person because he or she is a guest came from far away.” and such a feeling can be transmitted to the person at remote site and become a psychological burden, which can cause interference with natural and continuous communication between the two.

Thus, there is room for improvement in the conventional technology for natural and continuous communication between different sites using the telexistence technology.

This specification discloses a technology capable of solving the above-described problems.

### Solution to Problem

The technology disclosed herein may be implemented in the following forms, for example.

(1) The robot disclosed herein includes a display, a camera, a communication interface, a moving mechanism for moving the robot, and a control unit. The control unit includes a movement control unit, a remote video image processing unit, and a local video image processing unit. The movement control unit controls the moving mechanism to move the robot. The remote video image processing unit acquires a remote video image including video images representing a plurality of remote users located at sites different from the current location of the robot from an external network via the communication interface, and displays the acquired remote video image on the display. The local video image processing unit transmits a local video image, which is a video image captured by the camera, to the external network via the communication interface to cause the plurality of remote users to view the local video image.

In the present robot, the movement control unit controls the moving mechanism to move the robot, the remote video image processing unit displays remote video images including images representing the plurality of remote users on the display, and the local video image processing unit causes the plurality of remote users to view a local video image, which is a video image captured by the camera. In other words, the present robot functions as a collective telexistence device capable of being possessed by a plurality of remote users. This establishes a group-to-group relationship among remote users and local users instead of individual-to-group relationship, thereby mitigating the psychological burden of the remote user. Further, the plurality of remote users possessing the robot share an experience as if they were riding on the same robot, which will create a feeling of familiarity among the plurality of remote users. Thus, the present robot can implement natural and continuous communication among users located at mutually different sites.

(2) In the above-described robot, the control unit may further include an information space construction unit that constructs an information space shared by the plurality of remote users in the external network, and the local video image processing unit may project the local video image to the information space to cause the plurality of remote users virtually located in the information space to view the local video image. With this configuration, a plurality of remote users located at different sites can virtually gather in one information space and communicate with local users without actually gathering at one site.

(3) In the above-described robot, the remote video image may include images of the avatars of the plurality of remote users. This configuration eliminates the necessity for a remote user to use a device having a camera function and implements communication using more flexible and various video image expressions.

(4) In the above-described robot, the display may be a 360 degree display. This configuration can implement a more realistic visual communication among users located at different sites.

(5) In the above-described robot, the camera may be a 360 degree camera. This configuration can implement a more realistic visual communication among users located at different sites.

(6) The above-described robot may further include a 360 degree microphone, and the control unit may further include a local sound processing unit that transmits the local sound, which is the sound acquired by the 360 degree microphone, to the external network via the communication interface to cause the plurality of remote users to hear the sound in a manner in which the direction of the source of the sound is recognizable. This configuration can implement a more realistic auditory communication among users located at different sites.

(7) The above-described robot may further include a directional speaker, and the control unit may further include a remote sound processing unit that acquires remote sound, which is a sound emitted from the plurality of remote users, from the external network via the communication interface, and outputs the acquired remote sound from the directional speaker in a manner in which the direction of the remote users is recognizable. This configuration can implement a more realistic auditory communication among users located at different sites.

(8) The robot may further include a robot arm, and the control unit may further include a robot arm control unit that receives operation instructions from the plurality of remote users from the external network via the communication interface and operates the robot arm in response to the received operation instructions. The present configuration implements communication (interaction) through the robot arm among users located at different sites.

The technology disclosed herein can be implemented in various forms, such as a robot, a robot controller, a robot system including a robot and a robot controller, a robot control method, a computer program for implementing these methods, and a non-temporary recording medium on which the computer program is recorded, among other forms.

### BRIEF DESCRIPTION OF DRAWINGS

FIG. 1 is an explanatory diagram schematically illustrating a configuration of a remote communication system 10 according to a first embodiment.

FIG. 2 is a perspective view illustrating an external configuration of a robot 100.

FIG. 3 is a block diagram illustrating a functional configuration of the robot 100.

FIG. 4 is a block diagram illustrating a functional configuration of an HMD 200.

FIG. 5 is a chart illustrating a remote communication process flow executed in the remote communication system 10 of the first embodiment.

FIG. 6 is a diagram illustrating a configuration of a conventional robot 100X.

FIG. 7 is a diagram schematically illustrating a configuration of a remote communication system 10a according to a second embodiment.

FIG. 8 is a chart illustrating a remote communication process flow executed in the remote communication system 10a according to the second embodiment.

### DESCRIPTION OF EMBODIMENTS

### A. First Embodiment

### A-1. Configuration of Remote Communication System 10

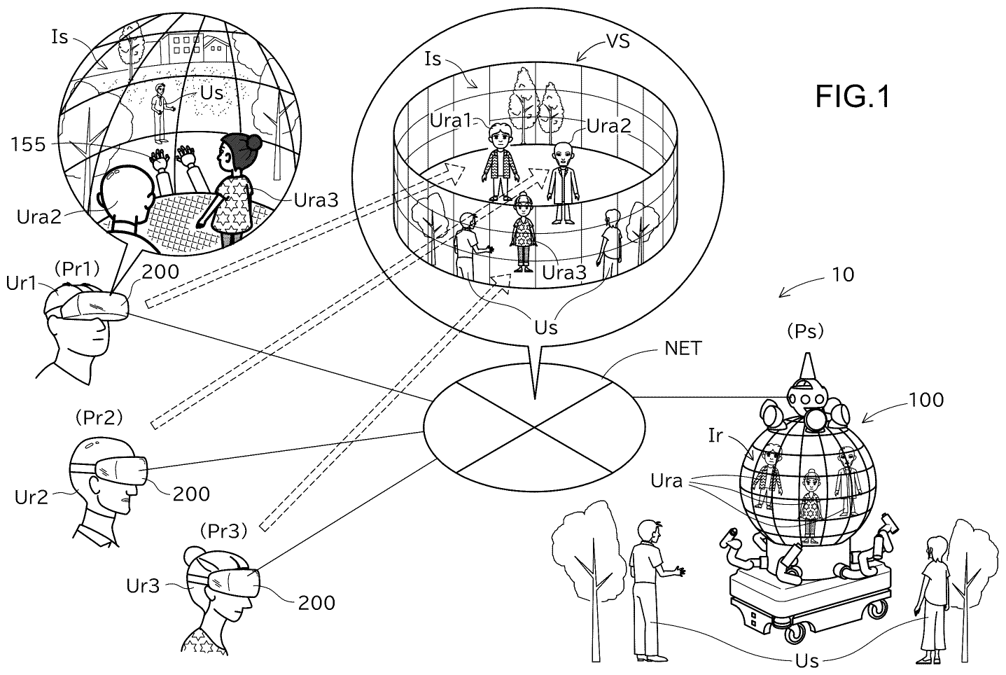

FIG. 1 is an explanatory diagram schematically illustrating a configuration of a remote communication system 10 according to a first embodiment. The remote communication system 10 according to the present embodiment is a system for implementing real-time communication among users located at mutually different sites by using telexistence technology.

In the example shown in FIG. 1, the remote communication system 10 implements communication among five users U located at any one of four different sites (four different points) P. The following description is explained from the view point of the robot 100, which will be described later; therefore, among the four sites P different from one another, the site P where the robot 100 is located is referred to as the local site (the standard site) Ps, and the other three sites P are referred to as the first remote site Pr1, the second remote site Pr2, and the third remote site Pr3, respectively. Hereinafter, the first remote site Pr1, the second remote site Pr2, and the third remote site Pr3 are collectively referred to as “remote site Pr”. It should be noted that from the view point of the first remote site Pr1, the local site Ps will be regarded as a “remote site”.

The local site Ps includes two users U (hereinafter referred to as “local users Us”). In addition, the first remote site Pr1 includes one user U (hereinafter referred to as the “first remote user Ur1”), the second remote site Pr2 includes one user U (hereinafter referred to as the “second remote user Ur2”), and the third remote site Pr3 includes one user U (hereinafter referred to as the “third remote user Ur3”). Hereinafter, the first remote user Ur1, the second remote user Ur2, and the third remote user Ur3 are collectively referred to as “remote user Ur”. In the example of FIG. 1, one user U is located at each remote site Pr, but a plurality of users U may be located at any of the remote sites Pr.

The remote communication system 10 includes a robot 100 and a head-mounted display (hereinafter referred to as “HMD”) 200. The devices constituting the remote communication system 10 are communicably connected to one another via an external network NET such as the Internet. In the example of FIG. 1, the remote communication system 10 includes one robot 100 and three HMDs 200. One robot 100 is located at the local site Ps and faces the local users Us. Each of the three HMDs 200 is mounted on a head of each of the three remote users Ur located at the remote sites Pr.

### Configuration of Robot 100

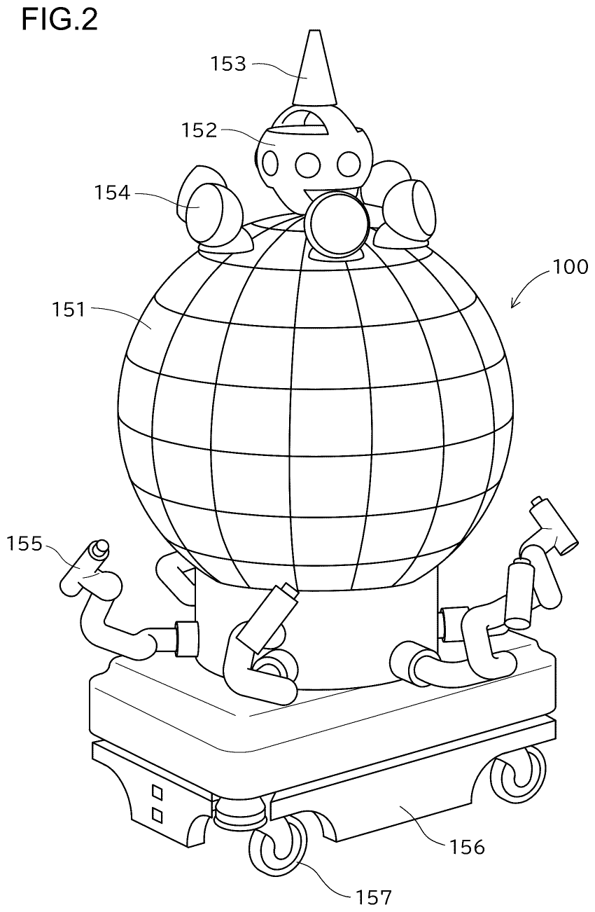

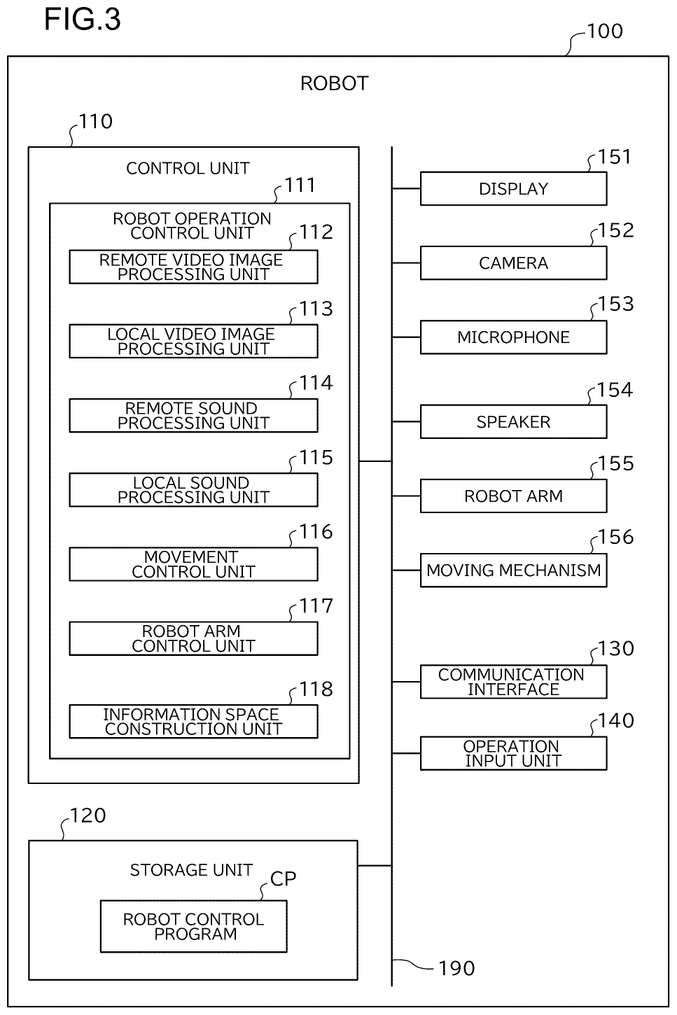

FIG. 2 is a perspective view illustrating an external configuration of the robot 100, and FIG. 3 is a block diagram illustrating a functional configuration of the robot 100. The robot 100 is a device for implementing communication between sites different from each other by allowing the users U to possess (dominate) the robot 100 by using the telexistence technology. As will be described later, the robot 100 functions as a collective telexistence device capable of being possessed by a plurality of users U at remote sites Pr.

As shown in FIGS. 2 and 3, the robot 100 includes a display 151, a camera 152, a microphone 153, a speaker 154, a robot arm 155, a moving mechanism 156, a communication interface 130, an operation input unit 140, a control unit 110, and a storage unit 120. These components are communicably connected to one another via a bus 190.

The display 151 of the robot 100 is a device for displaying various kinds of images according to digital image data, and is composed of, e.g., a liquid crystal display or an organic EL display. In this embodiment, the display 151 is a substantially spherical display, and substantially the entire outer peripheral surface of the sphere is used as a display surface.

The camera 152 of the robot 100 is a device for generating digital video image data by capturing video images via an image sensor. In the present embodiment, the camera 152 is a 360 degree camera capable of generating a 360 degree global celestial video image. As used herein, the term “360 degrees” is not necessarily limited to a strict 360 degrees, but means approximately 360 degrees. The camera 152 is arranged above the display 151. The camera 152 is preferably capable of generating high resolution digital video image data such as 8K or 16K data.

The microphone 153 of the robot 100 is a device for generating digital sound data according to the input sound. In this embodiment, the microphone 153 is a 360 degree surround microphone capable of collecting sound from 360 degrees around the microphone 153. The microphone 153 is arranged above the display 151 and the camera 152.

The speaker 154 of the robot 100 is a device for reproducing sound according to digital sound data. In the present embodiment, a plurality of directional speakers 154 are arranged above the display 151 at substantially equal intervals along the circumferential direction.

The robot arm 155 of the robot 100 is a mechanical arm capable of performing operations such as grasping, releasing, and carrying objects. In the present embodiment, a plurality of robot arms 155 are arranged at substantially equal intervals along the circumferential direction at positions below the display 151.

The moving mechanism 156 of the robot 100 constitutes the lowest part of the robot 100 and moves the robot 100. Specifically, the moving mechanism 156 includes wheels 157 and a drive unit (not shown) for driving the wheels 157 to move the robot 100 according to the operation by, e.g., the remote user Ur and/or the local user Us. In the present embodiment, the moving mechanism 156 has a sensor (e.g., LiDAR, radar, far infrared cameras, and ultrasonic sensors), which is not shown, and can autonomously move the robot 100 without human operation.

The communication interface 130 of the robot 100 is an interface for performing communication with, e.g., another device in the external network NET through a predetermined communication scheme. The communication interface 130 is preferably capable of performing communication conforming to a next-generation mobile communication scheme such as B5G or 6G. The operation input unit 140 of the robot 100 is composed of, e.g., a touch panel, buttons, a keyboard, and a microphone to receive operations and instructions from an operator.

The storage unit 120 of the robot 100 is composed of, e.g., ROM, RAM, HDD, and SSD, and is used for storing various programs and data or used as a work area for executing various programs or as a temporary storage area for data. For example, the storage unit 120 stores a robot control program CP for controlling the robot 100. The robot control program CP is provided in a state of being stored in a computer-readable recording medium (not shown) such as a CD-ROM, DVD-ROM or USB memory, or in a state of being obtainable from an external device (a server on an external network NET or other terminal device) via the communication interface 130, and is stored in the storage unit 120 in a state of being operable on the robot 100.

The control unit 110 of the robot 100 is constituted by, e.g., a CPU and controls the operation of each unit of the robot 100 by executing a computer program retrieved from the storage unit 120. For example, the control unit 110 retrieves the robot control program CP from the storage unit 120 and executes it to function as a robot operation control unit 111 for controlling the operation of each unit of the robot 100. The robot operation control unit 111 includes a remote video image processing unit 112, a local video image processing unit 113, a remote sound processing unit 114, a local sound processing unit 115, a movement control unit 116, a robot arm control unit 117, and an information space construction unit 118. The functions of these units will be described in detail later.

### Configuration of HMD 200

As shown in FIG. 1, the HMD 200 is a device to be mounted on the head of a user U to cause the user U to view a video image. In this embodiment, the HMD 200 is a non-transparent HMD that completely covers both eyes of the user U to provide the user U with a virtual reality (VR) experience. The HMD 200 also has a sound input/output function to provide the user U with a visual and auditory VR experience. Furthermore, the HMD 200 may be capable of providing the user U with a VR experience through other senses (e.g., touch).

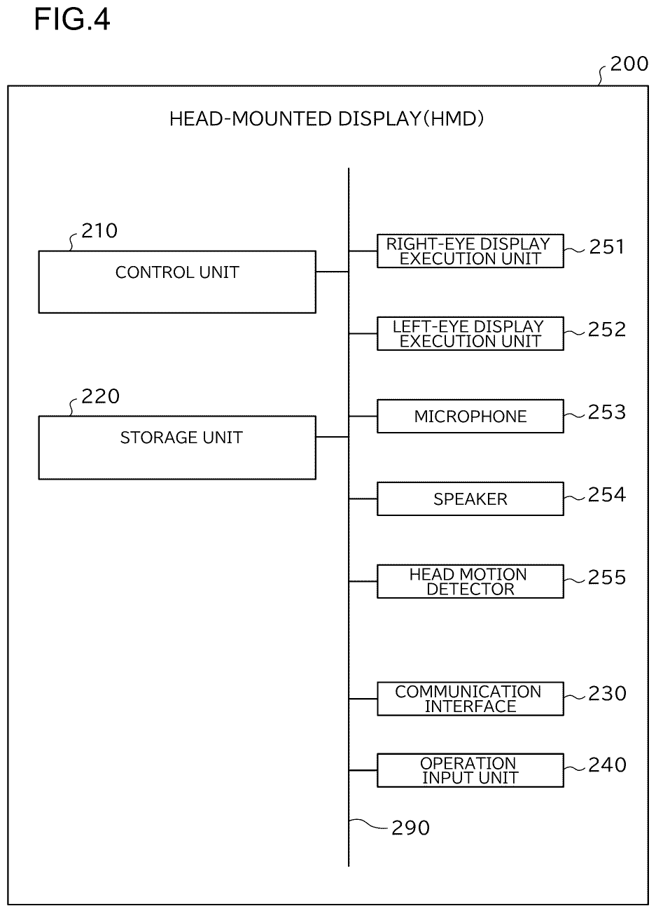

FIG. 4 is a block diagram illustrating a functional configuration of the HMD 200. The HMD 200 includes a right-eye display execution unit 251, a left-eye display execution unit 252, a microphone 253, a speaker 254, a head motion detector 255, a communication interface 230, an operation input unit 240, a control unit 210, and a storage unit 220. These units are communicably connected to one another via a bus 290.

The right-eye display execution unit 251 of the HMD 200 includes, e.g., a light source, a display element (e.g., a digital mirror device (DMD) and a liquid crystal panel), and an optical system, generates light representing the right-eye image (image to be viewed by the right-eye), and guides the light to the right eye of the user U, thereby making the right-eye image visible to the right eye of the user U. The left-eye display execution unit 252 is provided independently of the right-eye display execution unit 251, and as with the right-eye display execution unit 251, includes, e.g., a light source, a display element, and an optical system, generates light representing the left-eye image (image to be viewed by the left-eye), and guides the light to the left eye of the user U, thereby making the left-eye image visible to the left eye of the user U. When the right eye of the user U views the right eye image and the left eye of the user U views the left eye image, the user U views the 3D image. The right-eye display execution unit 251 and the left-eye display execution unit 252 are preferably capable of reproducing high resolution digital video image data, e.g., 8K or 16K data.

The microphone 253 of the HMD 200 is a device that generates digital sound data according to an input sound. The speaker 254 of the HMD 200 is a device for reproducing sound according to digital sound data. In this embodiment, the speaker 254 is a directional speaker.

The head motion detector 255 of the HMD 200 is a sensor for detecting the motion of the HMD 200 (i.e., the motion of the head of the user U) to implement a so-called head tracking function. The motion of the head of the user U includes both of the positional change and directional change of the head of the user U. The right-eye display execution unit 251 and the left-eye display execution unit 252 switch images to be viewed by a user U according to the motion of the HMD 200 detected by the head motion detector 255, so that the user U views VR images naturally changing in accordance with the motion of the head.

The communication interface 230 of the HMD 200 is an interface for performing communication with another device or the like in the external network NET through a predetermined communication scheme. The communication interface 230 is preferably capable of performing communication conforming to a next-generation mobile communication scheme such as, e.g., B5G or 6G. The operation input unit 240 of the HMD 200 is composed of, e.g., a touch panel or buttons to receive operations and instructions from the user U. The operation input unit 240 may be disposed inside a housing (the portion mounted on the head of the user U) of the HMD 200, or may be configured as a separate console connected to the housing via a signal line.

The storage unit 220 of the HMD 200 is composed of, e.g., ROM, RAM, and SSD, and is used for storing various programs and data or used as a work area for executing various programs or as a temporary storage area for data. The control unit 210 of the HMD 200 is configured by, e.g., a CPU and controls the operation of each unit of the HMD 200 by executing a computer program retrieved from the storage unit 220.

### A-2. Remote Communication Process

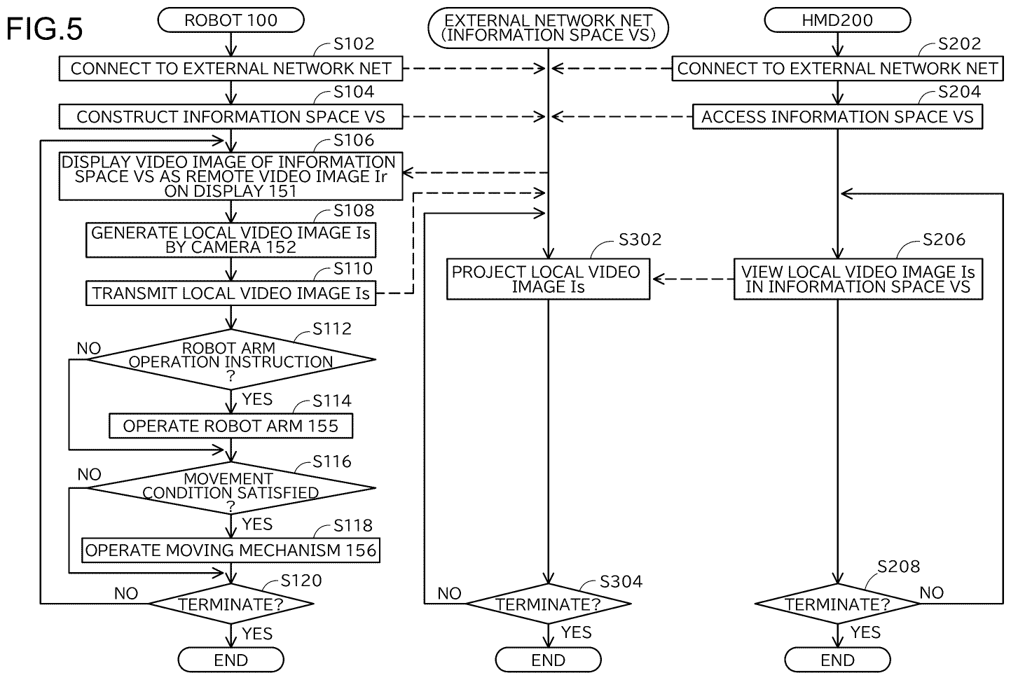

Next, the remote communication process executed in the remote communication system 10 according to the first embodiment will be described. The remote communication process is a process for implementing real-time communication through visual and/or auditory sense among users U located at sites different from one another. FIG. 5 is a chart illustrating a remote communication process flow executed in the remote communication system 10 of the first embodiment.

First, the robot operation control unit 111 (FIG. 3) of the robot 100 connects to the external network NET via the communication interface 130 (S102), and the information space construction unit 118 constructs an information space VS on the external network NET (S104). As shown in FIG. 1, the information space VS is a three-dimensional virtual space such as a metaverse, and in this embodiment, it is a space simulating an internal space of the robot 100. The information space VS is constructed, e.g., on a server (not shown) in the external network NET.

The control unit 210 of each HMD 200 connects to the external network NET via the communication interface 230 (S202) and accesses the information space VS on the external network NET (S204). As a result, as shown in FIG. 1, each remote user Ur (the first remote user Ur1, the second remote user Ur2, and the third remote user Ur3) mounting the HMD 200 is virtually located in the information space VS as an avatar (a first remote user avatar Ura1, a second remote user avatar Ura2, and a third remote user avatar Ura3). As described above, since the information space VS is a space simulating the internal space of the robot 100, each remote user Ur virtually located in the information space VS possesses (dominates) the robot 100 via the information space VS. Therefore, the plurality of remote users Ur are in a state as if they were riding on the same robot 100.

The remote video image processing unit 112 (FIG. 3) of the robot 100 acquires the remote video image Ir, which is a video image representing a scene of the information space VS, via the communication interface 130, and displays the acquired remote video image Ir on the display 151 (S106). Since a plurality of remote users Ur are virtually located in the information space VS, the remote video image Ir includes a video image representing a plurality of remote users Ur (more specifically, video image of avatars Ura of the remote users Ur). As shown in FIG. 1, by displaying the remote video image Ir on the display 151 of the robot 100, each local user Us at the local site Ps can view the remote video image Ir including the video image of the avatar Ura of each remote user Ur. In other words, each local user Us located at the local site Ps can recognize that the robot 100 is possessed by the plurality of remote users Ur.

The local video image processing unit 113 (FIG. 3) of the robot 100 captures a video image by using the camera 152 to generate a local video image Is (S108) and transmits the generated local video image Is to the information space VS via the communication interface 130 (S110), thereby projecting the local video image Is to the information space VS (S302). Thus, each remote user Ur can view the local video image Is projected to the information space VS via the HMD 200 (S206). As shown in FIG. 1, e.g., the first remote user Ur1 possessing the robot 100 via the information space VS views local video image Is as the surrounding scenery of the robot 100. It should be noted that the first remote user Ur1 also views the avatars Ura of the other remote users Ur virtually located in the information space VS (specifically, the second remote user avatar Ura2 and the third remote user avatar Ura3).

Although not shown in FIG. 5, the local sound processing unit 115 (FIG. 3) of the robot 100 uses the microphone 153 to generate a sound of a local site Ps including the voice of each local user Us (hereinafter referred to as “local sound”) and transmits the generated local sound to the information space VS via the communication interface 130. Thus, the local sound is reproduced by the speaker 254 of each HMD 200 in a manner in which the direction of the source of the sound is recognizable. In addition, the remote sound processing unit 114 (FIG. 3) of the robot 100 acquires the sound of the remote site Pr including the voice of each remote user Ur (hereinafter referred to as “remote sound”) generated by the microphone 253 of each HMD 200 via the communication interface 130 and reproduces the acquired remote sound by the speaker 154 in a manner in which the direction of the source of the sound (in the example of FIG. 1, the direction of the avatar Ura of each remote user Ur) is recognizable.

In this case, two local users Us are actually located at the local site Ps, and three remote users Ur are virtually located at the local site Ps by possessing the robot 100 via the information space VS. Therefore, five users U located at different sites from one another can virtually gather at the local site Ps and communicate with one another through visual communication and auditory communication. It should be noted that, since the plurality of remote users Ur share one information space VS, communication among the remote users Ur can also be naturally performed.

The robot arm control unit 117 (FIG. 3) of the robot 100 monitors the presence or absence of the robot arm operation instruction (S112), and in the case of the presence of the robot arm operation instruction (S112: YES), operates the robot arm 155 in accordance with the instruction (S114). In this embodiment, the remote user Ur can issue a robot arm operation instruction via the operation input unit 240 of the HMD 200. Thus, the remote user Ur can communicate with (e.g., shake hand with or do a high-five with) the local user Us through the robot arm 155, and can perform some operations on objects placed in the local site Ps.

The movement control unit 116 (FIG. 3) of the robot 100 monitors whether or not the movement condition is satisfied (S116), and when the movement condition is satisfied (S116: YES), operates the moving mechanism 156 to move the robot 100 (S118). In this embodiment, the remote user Ur can issue a movement instruction of the robot 100 via the operation input unit 240 of the HMD 200, and the movement condition may be the fact that the movement instruction has been issued. Therefore, the remote user Ur can move the currently possessing robot 100 by issuing a movement instruction, so that the remote user Ur can virtually move himself/herself at the local site Ps. The virtual movement of the remote user Ur naturally changes the local video image Is viewed by the remote user Ur. The movement instruction by the remote user Ur may be automatically issued when the remote user Ur actually moves in the remote site Pr and the head motion detector 255 of the HMD 200 detects the motion of the movement.

The movement condition may be other conditions in addition to or instead of the movement instruction by the remote user Ur. For example, the movement condition may be a movement instruction by the local user Us. The local user Us can issued the movement instruction via the operation input unit 140 of the robot 100 or via a terminal device (not shown) capable of communicating with the robot 100. The moving condition may be the fact that the distance between the local user Us and the robot 100 is changed by the movement of the local user Us. In this way, the robot 100 can follow the local user Us.

In the remote communication system 10, the above-described processing is repeated to continue the communication among users U located at sites different from one another unless one of the devices receives a termination instruction (S120, S304, S208). When one of the devices receives the termination instruction (S120: YES, S304: YES, S208: YES), the remote communication system 10 terminates the remote communication process.

### A-3. Effect of Embodiment 1

As described above, the robot 100 constituting the remote communication system 10 of the first embodiment includes: the display 151; the camera 152; the communication interface 130; the moving mechanism 156 for moving the robot 100; and the control unit 110. The control unit 110 includes the movement control unit 116, the remote video image processing unit 112, and the local video image processing unit 113. The movement control unit 116 controls the moving mechanism 156 to move the robot 100. The remote video image processing unit 112 acquires a remote video image Ir including video images representing a plurality of remote users Ur located at a site different from the local site of the robot 100 from the external network NET through the communication interface 130, and displays the acquired remote video image Ir on the display 151. The local video image processing unit 113 transmits the local video image Is, which is a video image captured by the camera 152, to the external network NET via the communication interface 130 to cause the plurality of remote users Ur to view the local video image Is.

As described above, in the robot 100 of the present embodiment, the movement control unit 116 controls the moving mechanism 156 to move the robot 100, the remote video image processing unit 112 displays the remote video image Ir including video images representing the plurality of remote users Ur on the display 151, and the local video image processing unit 113 causes the plurality of remote users Ur to view the local video image Is, which is a video image captured by the camera 152. Therefore, the robot 100 functions as a collective telexistence device capable of being possessed by a plurality of remote users Ur. Accordingly, the robot 100 can implement real-time communication among a plurality of remote users Ur possessing the robot 100 and local users Us actually located at the current location (local site Ps) of the robot 100.

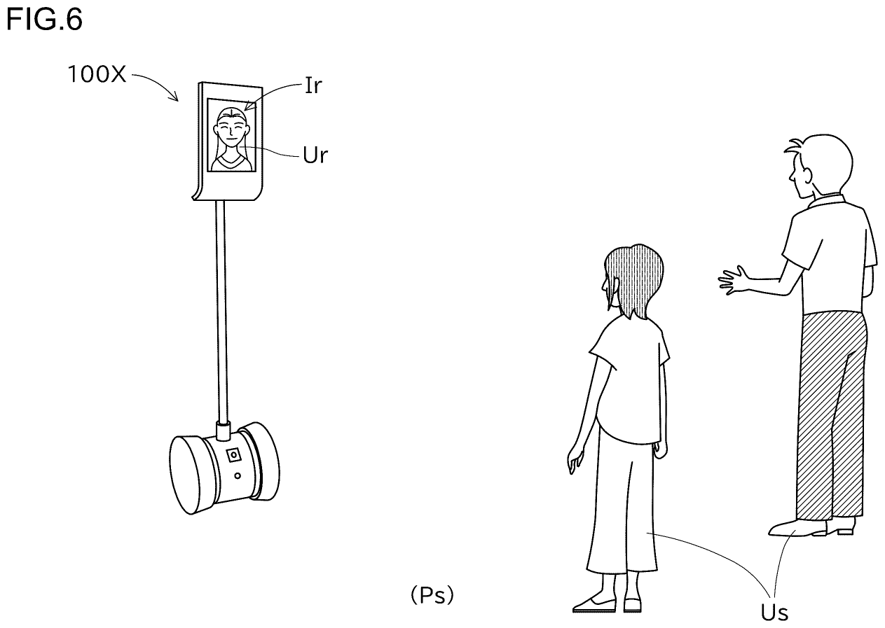

Here, as shown in FIG. 6, a conventional robot 100X (a telexistence device) capable of being possessed by only one remote user Ur can implement real-time communication among one remote user Ur possessing the robot 100X and local users Us actually located at the current location (local site Ps) of the robot 100X. However, the conventional robot 100X tends to create a psychological gap in the communication. For example, the local user Us tends to think, “I have to keep talking with this person because he or she is a guest came from far away.” and such a feeling can be transmitted to the remote user Ur and become a psychological burden, which can cause interference with natural and continuous communication between the two.

On the contrary, the robot 100 of the present embodiment can be possessed by a plurality of remote users Ur. This establishes a group-to-group relationship among remote users Ur and local users Us instead of individual-to-group relationship, thereby mitigating the psychological burden of the remote user Ur. Further, the plurality of remote users Ur possessing the robot 100 share an experience as if they were riding on the same robot 100, which will create a feeling of familiarity among the plurality of remote users Ur. Thus, the robot 100 of the present embodiment can implement natural and continuous communication among the plurality of remote users Ur and the local users Us.

In the present embodiment, the control unit 110 of the robot 100 further includes the information space construction unit 118 for constructing an information space VS shared by a plurality of remote users Ur in the external network NET, and the local video image processing unit 113 projects the local video image Is to the information space VS, thereby causing the plurality of remote users Ur virtually located in the information space VS to view the local video image Is. Therefore, with the robot 100 of the present embodiment, a plurality of remote users Ur located at different sites can virtually gather in one information space VS and communicate with local users Us without actually gathering at one site.

In the present embodiment, the remote video image Ir includes video images of the avatars Ura of the plurality of remote users Ur. Therefore, the robot 100 of the present embodiment eliminates the necessity for a remote user Ur to use a device having a camera function and implements communication using more flexible and various video image expressions.

In the present embodiment, the display 151 of the robot 100 is a 360 degree display. Therefore, the robot 100 can implement a more realistic visual communication among the plurality of remote users Ur and the local users Us.

In the present embodiment, the camera 152 of the robot 100 is a 360 degree camera. Therefore, the robot 100 of the present embodiment can implement a more realistic visual communication among the plurality of remote users Ur and the local users Us.

In the present embodiment, the robot 100 further includes the microphone 153 which is a 360 degree microphone, and the control unit 110 further includes the local sound processing unit 115 for transmitting the local sound, which is the sound acquired by the microphone 153, to the external network NET via the communication interface 130 to cause the plurality of remote users Ur to hear the sound in a manner in which the direction of the source of the sound is recognizable. Therefore, the robot 100 of the present embodiment can implement a more realistic auditory communication among the plurality of remote users Ur and the local users Us.

In addition, in the present embodiment, the robot 100 further includes the speaker 154 having directivity, and the control unit 110 further includes the remote sound processing unit 114 that acquires remote sound, which is a sound emitted from a plurality of remote users Ur, from the external network NET via the communication interface 130, and outputs the acquired remote sound from the speaker 154 in a manner in which the direction of each remote user Ur is recognizable. Therefore, the robot 100 of the present embodiment can implement a more realistic auditory communication among the plurality of remote users Ur and the local users Us.

In the present embodiment, the robot 100 further includes the robot arm 155, and the control unit 110 further includes the robot arm control unit 117 that receives operation instructions from a plurality of remote users Ur via the communication interface 130 from the external network NET and operates the robot arm 155 in response to the received operation instructions. Therefore, the robot 100 of this embodiment can implement a communication (interaction) through the robot arm 155 among the plurality of remote users Ur and the local users Us.

### B. Second Embodiment

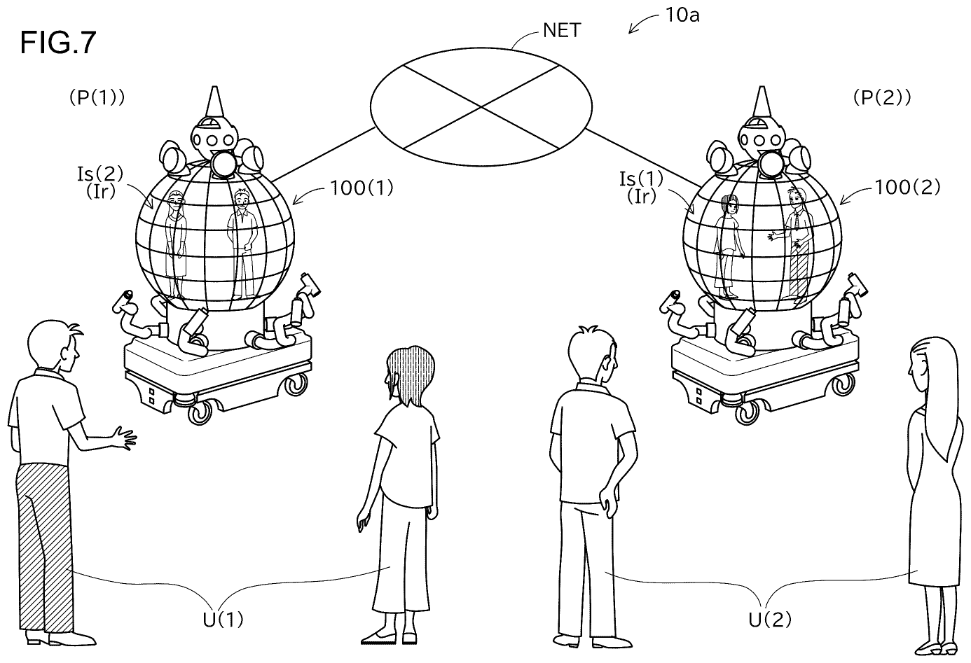

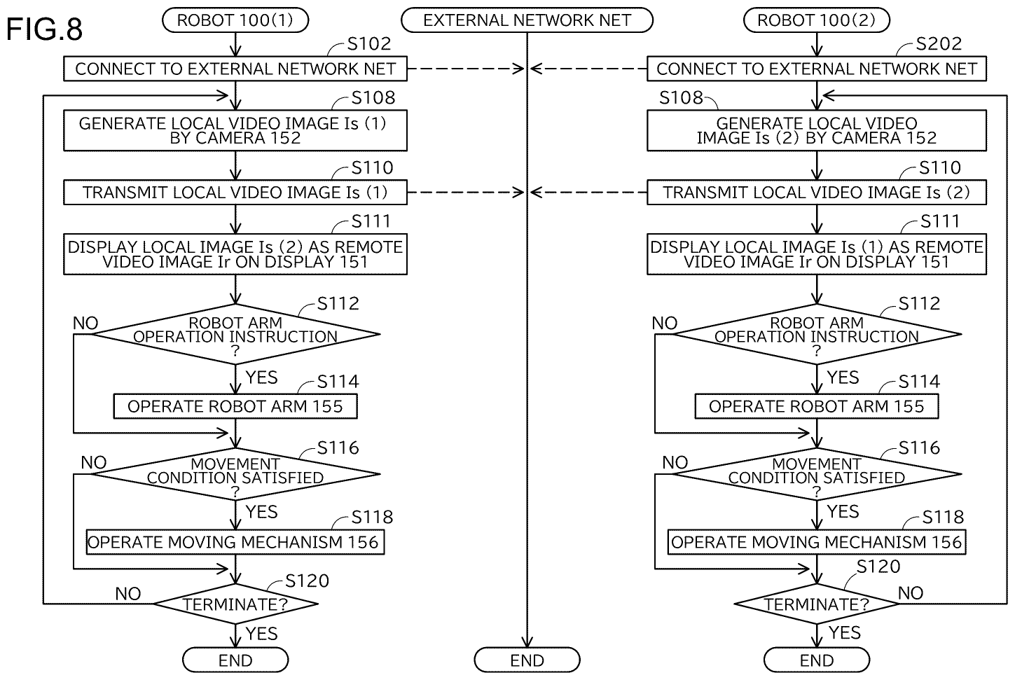

FIG. 7 is an explanatory diagram schematically illustrating a configuration of a remote communication system 10a in a second embodiment, and FIG. 8 is a chart illustrating a remote communication process flow executed in the remote communication system 10a according to the second embodiment. Hereinafter, in the configuration of the remote communication system 10a of the second embodiment and the process contents of the remote communication process, the same configuration and process contents as those of the first embodiment described above are appropriately omitted by assigning the same reference numerals.

The remote communication system 10a of the second embodiment includes two robots 100. The two robots 100 are communicatively connected to each other via the external network NET. The configuration of each robot 100 is the same as that of the robot 100 in the first embodiment.

One of the two robots 100 (hereinafter, referred to as “the first robot 100 (1)”) is located at a certain site P (hereinafter referred to as “the first site P (1)”), and the other of the two robots 100 (hereinafter, referred to as “the second robot 100 (2)”) is located at a site P different from the first site P (1) (hereinafter referred to as “the second site P (2)”). From the view point of the first robot 100 (1), the first site P (1) where the first robot 100 (1) is located will be regarded as the “local site”, and the second site P (2) where the second robot 100 (2) is located will be regarded as the “remote site”. On the contrary, from the view point of the second robot 100 (2), the second site P (2) where the second robot 100 (2) is located will be regarded as the “local site”, and the first site P (1) where the first robot 100 (1) is located will be regarded as the “remote site”.

A plurality of (in the example of FIG. 7, two) users U (first user U (1) and second user U (2)) are located at the first site P (1) and the second site P (2), respectively, and face the robot 100 located at each site P. The remote communication system 10a of the second embodiment implements real-time communication among the plurality of first users U (1) at the first site P (1) and the plurality of second users U (2) at the second site P (2).

As shown in FIG. 8, in the remote communication process executed in the remote communication system 10a, the robot operation control unit 111 (FIG. 3) of the first robot 100 (1) connects to the external network NET via the communication interface 130 (S102). The local video image processing unit 113 (FIG. 3) of the first robot 100 (1) captures a video image by using the camera 152 to generate a first local video image Is (1) (S108) and transmits the generated first local video image Is (1) to the external network NET via the communication interface 130 (S110). In the example of FIG. 7, since the two first users U (1) face the first robot 100 (1), the first local video image Is (1) includes a video image (more specifically, the actual image of the first users U (1)) representing the two first users U (1). It should be noted that this first local video image Is (1) will be regarded as a “remote video image” when viewed from the second robot 100 (2).

Similarly, the robot operation control unit 111 (FIG. 3) of the second robot 100 (2) connects to the external network NET via the communication interface 130 (S102). The local video image processing unit 113 (FIG. 3) of the second robot 100 (2) captures a video image by using the camera 152 to generate a second local video image Is (2) (S108), and transmits the generated second local video image Is (2) to the external network NET via the communication interface 130 (S110). In the example of FIG. 7, since the two second users U (2) face the second robot 100 (2), the second local video image Is (2) includes a video image (more specifically, the actual image of the second user U (2)) representing the two second users U (2). It should be noted that this second local video image Is (2) will be regarded as a “remote video image” when viewed from the first robot 100 (1).

The remote video image processing unit 112 of the first robot 100 (1) acquires the second local video image Is (2) transmitted from the second robot 100 (2) via the communication interface 130, and displays the acquired second local video image Is (2) as a remote video image Ir on the display 151 (S111). By displaying the second local video image Is (2) as the remote video image Ir on the display 151, each first user U (1) located at the first site P (1) can view the actual video image of each second user U (2) displayed on the display 151 of the first robot 100 (1). Thus, each first user U (1) at the first site P (1) can recognize that the first robot 100 (1) is possessed by the plurality of second users U (2).

Similarly, the remote video image processing unit 112 of the second robot 100 (2) acquires the first local video image Is (1) transmitted from the first robot 100 (1) via the communication interface 130, and displays the acquired first local video image Is (1) as a remote video image Ir on the display 151 (S111). By displaying the first local video image Is (1) as the remote video image Ir on the display 151, each second user U (2) at the second site P (2) can view the actual video image of each first user U (1) displayed on the display 151 of the second robot 100 (2). Thus, each of the second users U (2) at the second site P (2) can recognize that the second robot 100 (2) is possessed by the plurality of first users U (1).

In this case, two first users U (1) are actually located at the first site P (1), and two second users U (2) actually located at the second site P (2) are virtually located at the first site P (1) by possessing the first robot 100 (1). Similarly, two second users U (2) are actually located at the second site P (2), and two first users U (1) actually located at the first site P (1) are virtually located at the second site P (2) by possessing the second robot 100 (2). Therefore, four users U located at different sites from one another can virtually gather at the first site P (1) or the second site P (2) and communicate with one another through visual communication and auditory communication.

As with the first embodiment, the robot arm control unit 117 (FIG. 3) of each robot 100 monitors the presence or absence of the robot arm operation instruction (S112), and in the case of the presence of the robot arm operation instruction (S112: YES), operates the robot arm 155 in accordance with the instruction (S114). The movement control unit 116 (FIG. 3) of each robot 100 monitors whether or not the movement condition is satisfied (S116), and when the movement condition is satisfied (S116: YES), operates the moving mechanism 156 to move the robot 100 (S118).

The above-described processing is repeated to continue the communication among the users U located at sites different from one another unless one of the devices receives a termination instruction (S120). When one of the devices receives the termination instruction (S120: YES), the remote communication system 10a terminates the remote communication process.

As described above, in each robot 100 constituting the remote communication system 10a of the second embodiment, as with the first embodiment, the movement control unit 116 controls the moving mechanism 156 to move the robot 100, the remote video image processing unit 112 displays the remote video image Ir including video images representing the users U of the plurality of remote sites on the display 151, and the local video image processing unit 113 causes the users U of the plurality of remote sites to view the local video image Is, which is a video image captured by the camera 152. In other words, each of the robots 100 of the second embodiment functions as a collective telexistence device capable of being possessed by users U at the plurality of remote sites. Accordingly, each robot 100 of the second embodiment can implement real-time communication among a plurality of users U located at a plurality of remote sites possessing the robot 100 and users U actually located at the current location of the robot 100.

### C. Modifications

The technology disclosed herein is not limited to the above-described embodiments, and can be modified into various forms without departing from the spirit thereof, e.g., the following modifications are also possible.

The configuration of the remote communication system 10 in the above embodiment is merely an example and can be varied in various ways. For example, although the HMD 200 is used as a device for the remote user Ur to access the information space VS in the first embodiment, devices (e.g., PCs, smartphones, tablet terminals, and smart glasses, among others) other than the HMD 200 may be used. In the second embodiment, the robot 100 is used as the devices for communication at any of the two sites P, but devices (e.g., PCs, smartphones, tablet terminals, and smart glasses, among others) other than the robot 100 may be used at any of the two sites P.

The configuration of the robot 100 in the above embodiment is merely an example, and can be modified in various ways. For example, in the above embodiments, the display 151 is a 360 degree display, but the display 151 is not necessarily a 360 degree display. In the above embodiment, the camera 152 is a 360 degree camera, but the camera 152 is not necessarily a 360 degree camera. In the above embodiment, the microphone 153 is a 360 degree microphone, but the microphone 153 is not necessarily a 360 degree microphone. In the above embodiment, the speaker 154 is a directional speaker, but the speaker 154 is not necessarily a directional speaker.

In the above embodiment, the robot 100 may not include at least one of the microphone 153, the speaker 154, and the robot arm 155.

The process contents of the remote communication process in the above embodiment are only an example, and can be varied in various ways.

In the above embodiment, a part of the configuration implemented by a hardware may be substituted by a software, and on the contrary, a part of the configuration implemented by a software may be substituted by a hardware.

### REFERENCE SIGNS LIST

10: Remote communication system, 100 robot, 110 control unit, 111: robot operation control unit, 112 remote video image processing unit, 113: local video image processing unit, 114: remote sound processing unit, 115: local sound processing unit, 116: movement control unit, 117: robot arm control unit, 118: information space construction unit, 120: storage unit, 130: communication interface, 140: operation input unit, 151: display, 152: camera, 153: microphone, 154: speaker, 155: robot arm, 156: moving mechanism, 157: wheel, 190: bus, 200: HMD, 210: control unit, 220: storage unit, 230: communication interface, 240: operation input unit, 251: right-eye display execution unit, 252: left-eye display execution unit, 253: microphone, 254: speaker, 255: head motion detector, 290: bus, CP: robot control program, Ir: remote video image, Is: local video image, NET: external network, Pr1: first remote site, Pr2: second remote site, Pr3: third remote site, Ps: local site, Ur1: first remote user, Ur2: second remote user, Ur3: third remote user, Ura: avatar, Us: local user, VS: information space

1. A robot, comprising:
a display;
a camera;
a communication interface;
a moving mechanism for moving the robot; and
a control unit,
wherein the control unit includes:
a movement control unit that controls the moving mechanism to move the robot;
a remote video image processing unit that acquires a remote video image including video images representing a plurality of remote users located at sites different from the current location of the robot from an external network via the communication interface and displays the acquired remote video image on the display; and
a local video image processing unit that transmits a local video image, which is a video image captured by the camera, to the external network via the communication interface to cause the plurality of remote users to view the local video image.

2. The robot according to claim 1,
wherein the control unit further includes an information space construction unit that constructs an information space shared by the plurality of remote users on the external network, and
wherein the local video image processing unit projects the local video image to the information space to cause the plurality of remote users virtually located in the information space to view the local video image.

3. The robot according to claim 2,
wherein the remote video image includes video images of avatars of the plurality of remote users.

4. The robot according to claim 1,
wherein the display is a 360 degree display.

5. The robot according to claim 1,
wherein the camera is a 360 degree camera.

6. The robot according to claim 1, the robot further comprising:
a 360 degree microphone,
wherein the control unit further includes a local sound processing unit that transmits the local sound, which is the sound acquired by the 360 degree microphone, to the external network via the communication interface to cause the plurality of remote users to hear the sound in a manner in which the direction of the source of the sound is recognizable.

7. The robot according to claim 1, the robot further comprising:
a directional speaker,
wherein the control unit further includes a remote sound processing unit that acquires remote sound, which is a sound emitted from the plurality of remote users, from the external network via the communication interface, and outputs the acquired remote sound from the directional speaker in a manner in which the direction of the remote users is recognizable.

8. The robot according to claim 1, further comprising:
a robot arm,
wherein the control unit further includes a robot arm control unit that receives operation instructions from the plurality of remote users from the external network via the communication interface and operates the robot arm in response to the received operation instructions.

9. A robot control method for controlling a robot having a display, a camera, a communication interface, and a moving mechanism, comprising:
a step of controlling the moving mechanism to move the robot;
a step of acquiring a remote video image including video images representing a plurality of remote users located at sites different from the current location of the robot from an external network via the communication interface, and displaying the acquired remote video image on the display; and
a step of transmitting a local video image, which is a video image captured by the camera, to the external network via the communication interface to cause the plurality of remote users to view the local video image.

10. A computer program for controlling a robot having a display, a camera, a communication interface, and a moving mechanism,
the computer program causing a computer to perform:
a process of controlling the moving mechanism to move the robot;
a process of acquiring a remote video image including video images representing a plurality of remote users located at sites different from the current location of the robot from an external network via the communication interface, and displaying the acquired remote video image on the display; and
a process of transmitting a local video image, which is a video image captured by the camera, to the external network via the communication interface to cause the plurality of remote users to view the local video image.
